(19) United States
(12) Patent Application Publication
(10) Pub. No.: US 2014/0203656 A1
(43) Pub. Date: Jul. 24, 2014

(54) ELECTRONIC DEVICE, CONTROL METHOD, AND COMPUTER-READABLE STORAGE MEDIUM

(71) Applicant: KABUSHIKI KAISHA TOSHIBA, Tokyo (JP)

(72) Inventor: Makoto Yamaguchi, Sagamihara-shi (JP)

(73) Assignee: KABUSHIKI KAISHA TOSHIBA, Tokyo (JP)

(21) Appl. No.: 14/017,825

(22) Filed: Sep. 4, 2013

Related U.S. Application Data
(63) Continuation of application No. PCT/JP2013/058798, filed on Mar. 26, 2013.

(30) Foreign Application Priority Data
Jan. 24, 2013 (JP) 2013-011222

(51) Int. Cl. H01F 38/14

(52) U.S. Cl. CPC H01F 38/14
USPC 307/104

(57) ABSTRACT

According to one embodiment, an electronic device includes a power transmission coil portion, a housing, a detector, and a power transmitter. The power transmission coil portion comprises a power transmission coil for a contactless power feeding. The housing is configured to hold the power transmission coil portion such that the power transmission coil portion is able to be drawn or extruded from the housing. The detector is configured to detect whether the power transmission coil portion is drawn or extruded up to a preset state. The power transmitter is configured to transmit power by the power transmission coil when the power transmission coil portion is drawn or extruded up to the preset state.

### CROSS-REFERENCE TO RELATED APPLICATIONS

This application is a Continuation Application of PCT Application No. PCT/JP2013/058798, filed Mar. 26, 2013 and based upon and claiming the benefit of priority from Japanese Patent Application No. 2013-011222, filed Jan. 24, 2013, the entire contents of all of which are incorporated herein by reference.

### FIELD

Embodiments described herein relate generally to an electronic device, an electronic device control method, and a computer-readable storage medium.

### BACKGROUND

Recently, for example, there has been known a contactless power feeding that feeds power from a power feeding apparatus to an electronic device in a so-called contactless manner, without any electrical contact (connection) such as a connector.

Also, recently, for example, like a contactless power feeding from one electronic device to another electronic device, there has been a demand for a disclosure of a technology that enables a contactless power feeding between electronic devices.

For example, there has been a demand for transmitting power from an electronic device (for example, a personal computer (PC) or the like) to another electronic device by a contactless power feeding, even when a user uses the electronic device (PC).

However, when power transmission by the contactless power feeding is performed, some heat is generated from a power transmission coil. In this regard, it is preferable to refrain from power transmission by the contactless power feeding, for example, during the use of the electronic device (PC). This is inconvenient to a user.

Therefore, there has been a need for enabling power transmission by a contactless power feeding even during the use of an electronic device (PC), without particular care, and improving a user convenience.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram illustrating a power transmission of a contactless power feeding from an electronic device (PC) according to an embodiment to another electronic device (portable information terminal).

FIG. 2 is a side view illustrating the power transmission of the contactless power feeding from the electronic device (PC) according to the embodiment to another electronic device (portable information terminal).

FIG. 3 is a flowchart describing an operation of the electronic device (PC) according to the embodiment.

FIG. 4 is a diagram illustrating an electronic device (PC) according to another embodiment.

### DETAILED DESCRIPTION

Various embodiments will be described hereinafter with reference to the accompanying drawings.

In general, according to one embodiment, an electronic device includes a power transmission coil portion, a housing, a detector, and a power transmitter. The power transmission coil portion comprises a power transmission coil for a contactless power feeding. The housing is configured to hold the power transmission coil portion such that the power transmission coil portion is able to be drawn or extruded from the housing. The detector is configured to detect whether the power transmission coil portion is drawn or extruded up to a preset state. The power transmitter is configured to transmit power by the power transmission coil when the power transmission coil portion is drawn or extruded up to the preset state.

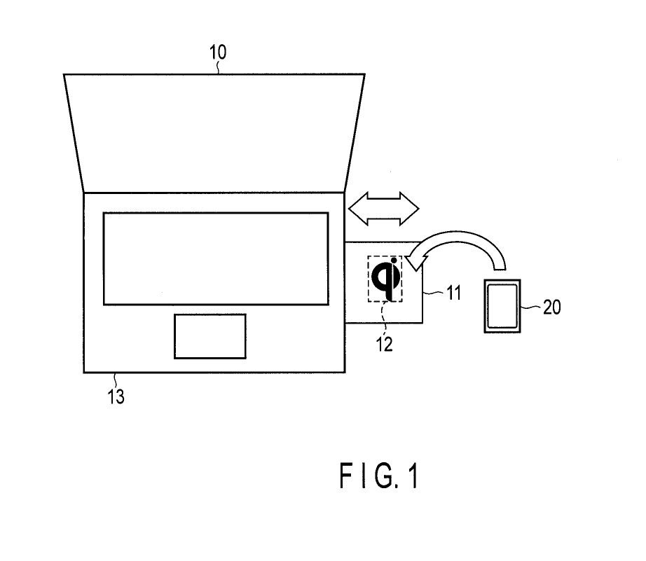

FIG. 1 is a diagram illustrating a power transmission of a contactless power feeding from an electronic device (PC) according to an embodiment to another electronic device (portable information terminal).

In this embodiment, the electronic device (PC) 10 includes a tray (power transmission coil portion) 11 embedded with a power transmission coil 12 of a contactless power feeding.

The power transmission coil portion (tray) 11, for example, is configured to be held in a housing 13 of the electronic device (PC) 10 and be able to be drawn or extruded from the electronic device (PC) 10 by sliding.

In this embodiment, by drawing or extruding the power transmission coil portion (tray) 11 embedded with the power transmission coil 12 from the housing 13, another electronic device (device, for example, a smartphone or the like) 20 embedded with a power reception coil of a contactless power feeding is placed on, for example, the power transmission coil portion (tray) 11. A power transmission of a contactless power feeding is performed from the electronic device (PC) 10 to another electronic device (device, for example, a smartphone or the like) 20.

Also, although the PC is exemplified and described herein as the electronic device 10, the electronic device according to the embodiment is not limited to the PC and may also be applied to a portable terminal, such as a tablet PC or a smartphone, or a television.

Herein, the contactless power feeding according to the embodiment will be described below.

The “contactless power feeding” refers to a contactless power transmission or a wireless energy transfer, and is used in, for example, a cordless telephone, an electric shaver, and an electric toothbrush.

The “contactless power feeding” is to transmit (feed) power without passing through a metal contact point, a connector or the like. The contactless power feeding is also called, for example, a wireless power feeding, a contactless power transmission, or a non-contact power transmission. When power is transmitted to a device embedded with a rechargeable battery, the contactless power feeding is also called, for example, a contactless charging (inductive charging).

The “contactless power feeding” uses, for example, a mutual induction effect of electromagnetism.

As illustrated in FIG. 1, the electronic device (PC) 10 according to the embodiment, for example, includes the housing 13.

Also, the electronic device (PC) 10 includes the power transmission coil 12, which is used for the contactless power feeding, in the power transmission coil portion 11 having, for example, a tray shape. In other words, the power transmission coil 12 is embedded in the tray-shaped power transmission coil portion 11.

The power transmission coil portion 11 is configured to be able to be held in the housing of the electronic device (PC) 10.

Also, the power transmission coil portion 11 is configured to slide with respect to the housing 13 by a mechanical control, an electrical control of a switch or the like, or a combination of the mechanical control and the electrical control.

The power transmission coil portion 11, for example, is configured to be able to be drawn or extruded from the housing 13 of the electronic device (PC) 10 by a manual manner, an electrically-operative manner, or a combination of the manual manner and the electrically-operative manner.

Also, although not particularly illustrated, the electronic device (PC) 10 includes a detector configured to detect whether the tray-shaped power transmission coil portion (receiving tray) 11 embedded with the power transmission coil 12 is drawn or extruded up to a preset state (a state in which it is determined that the power transmission coil 12 is sufficiently or completely pulled out from the housing 13 of the electronic device (PC) 10 to the outside such that the power transmission coil 12 does not greatly affect the electronic device (PC) 10) by a mechanical manner, an electrical manner, or a combination of the mechanical manner and the electrical manner.

The electronic device (PC) 10 includes a power transmitter configured to perform a power transmission of a contactless power feeding by using the power transmission coil 12 embedded in the power transmission coil portion (receiving tray) 11 when it is detected that the power transmission coil portion (receiving tray) 11 is drawn or extruded up to the preset state.

That is, in this embodiment, the tray (power transmission coil portion) 11 embedded with an electromagnetic induction feeding coil for power transmission (power transmission coil 12) is provided in the electronic device (PC) 10 in order for contactless power supply (contactless power feeding) to, for example, an external electronic device 20 outside the electronic device (PC) 10 (for example, a portable information device such as a smartphone).

Another electronic device (for example, the portable information terminal such as a smartphone) 20 receiving the power is embedded with, for example, a power reception coil configured to receive the power supplied from the electronic device (PC) 10.

Also, herein, in this embodiment, the electronic device (for example, the portable information terminal) 20 may be put (placed) on the power transmission coil portion (receiving tray) 11.

Also, the power transmission coil portion (receiving tray) 11 is configured to slide with respect to the housing 13 of the electronic device (PC) 10 and configured to be held in the housing 13 of the electronic device (PC) 10.

Also, the power transmission coil portion (receiving tray) 11 is configured to be drawn or extruded from the housing 13 of the electronic device (PC) 10.

Also, in this embodiment, although the power is supplied from the electronic device (PC) 10 to the external electronic device 20 by the contactless power feeding, the power transmission coil portion (receiving tray) 11 embedded with the electromagnetic induction feeding coil (power transmission coil 12) for power transmission used herein is provided.

Also, in this embodiment, the state in which the power transmission coil portion (receiving tray) 11 is sufficiently (completely) drawn (or extruded) is detected in order to reduce an influence of heat and noise on the inside of the electronic device (PC) 10 from the power transmission coil 12. The heat and the noise are generated by the power transmission (power transmission coil 12) in a state which the power transmission coil portion (receiving tray) 11 is held in the electronic device (PC) 10 or in a state which the power transmission coil portion (receiving tray) 11 is halfway drawn.

For example, when the state in which the power transmission coil portion (receiving tray) 11 is sufficiently (completely) drawn (or extruded) from the housing 13 is detected, the power transmission of the “contactless power feeding” is performed.

The state in which the power transmission coil portion (receiving tray) 11 is sufficiently (completely) drawn (or extruded) from the housing 13 is preset in, for example, the electronic device (PC) 10.

Also, in this embodiment, when the power transmission coil portion (receiving tray) 11 is not in the state of being sufficiently or completely drawn or extruded from the housing 13 of the electronic device (PC) 10, a control is performed such that the power feeding to another electronic device (for example, the portable information terminal such as the smartphone) 20 is not started.

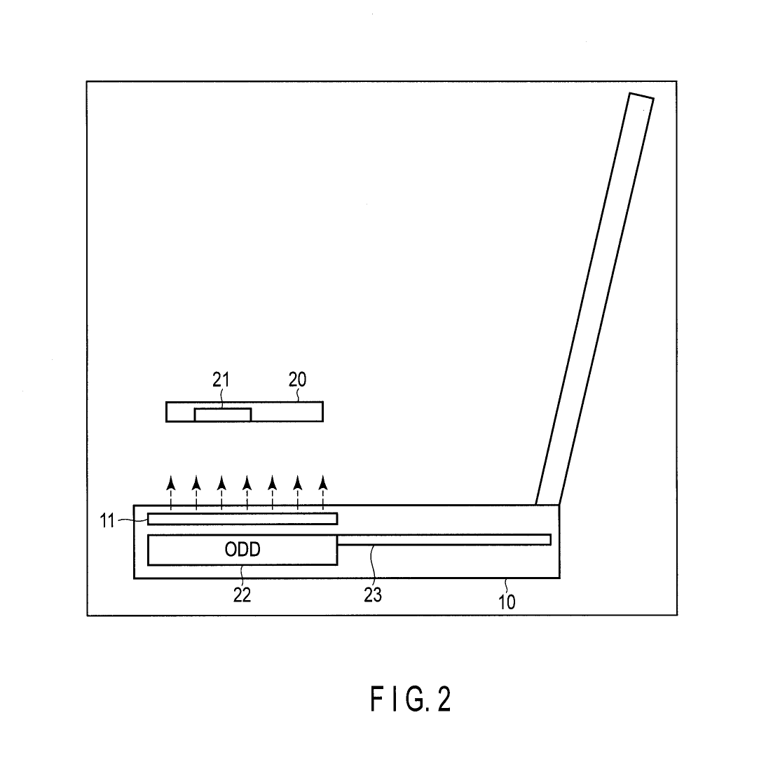

FIG. 2 is a diagram illustrating the power transmission of the contactless power feeding from the electronic device (PC) according to the embodiment to another electronic device (portable information terminal), from the perspective of a horizontal direction.

In this embodiment, as described above, the power transmission of the “contactless power feeding” is performed when the state in which the power transmission coil portion (receiving tray) 11 is sufficiently (completely) drawn (or extruded) from the housing 13 is detected.

Herein, for example, the power transmission coil portion (receiving tray) 11 of the electronic device (PC) 10 is sufficiently (completely) drawn (or extruded) from the housing 13, and this state is detected by the electronic device (PC) 10.

Then, for example, another electronic device (portable information terminal) 20 is placed on the power transmission coil portion (receiving tray) 11, and the contactless power feeding (power transmission) is performed from the power transmission coil 12 of the electronic device (PC) 10 to the reception coil 21 of another electronic device (portable information terminal) 20.

Also, in this embodiment, the power transmission coil portion 11 is configured to partially or entirely overlap an optical drive (ODD) 22 in a state of being held in the housing 13. This can improve, for example, a mounting efficiency of the electronic device (PC) 10. A central processing unit (CPU) or the like is mounted on a printed circuit board (system board) 23.

Also, herein, although another electronic device (portable information terminal) 20 is placed on the power transmission coil portion (receiving tray) 11 of the electronic device (PC) 10 and the power transmission coil portion (receiving tray) 11 contacts another electronic device (portable information terminal) 20, the power transmission coil 12 does not contact the reception coil 21, and the power feeding from the electronic device (PC) 10 to another electronic device (portable information terminal) 20 is the contactless power feeding.

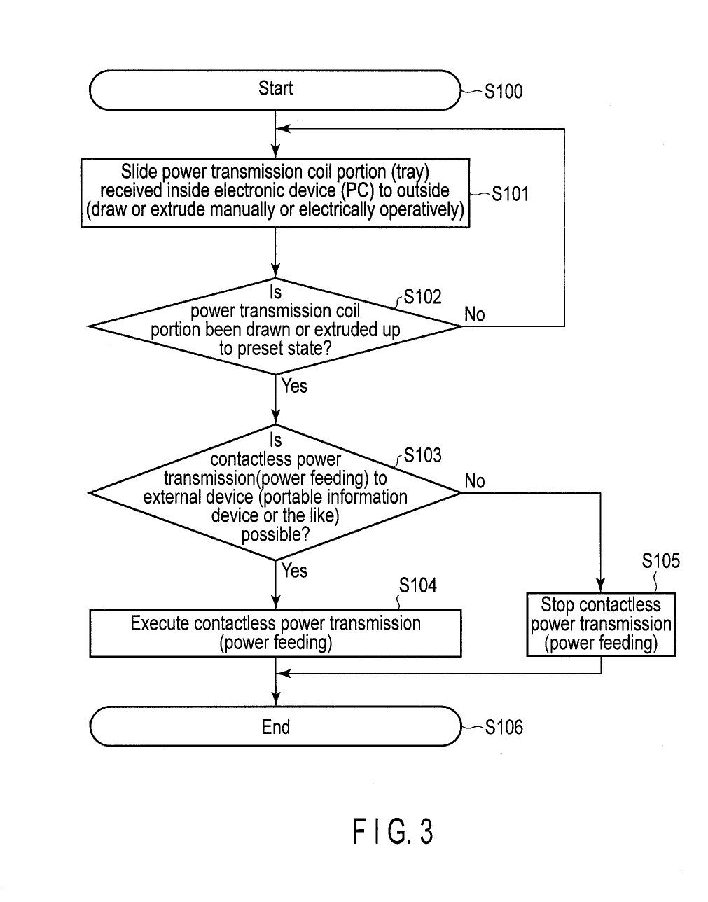

FIG. 3 is a flowchart describing the operation of the electronic device (PC) according to the embodiment.

Step S100 is a start step. The process proceeds to step S101.

In step S101, the power transmission coil portion (tray) 11 held in the electronic device (PC) 10 is slid toward the outside of the housing 13. At this step, the power transmission coil portion (tray) 11 is drawn or extruded from the housing 13. For example, the operation of drawing or extruding the power transmission coil portion (tray) 11 is manually performed by a user, or is performed in an electrically-operative manner under control of the electronic device (PC) 10. Subsequently, the process proceeds to step S102.

In step S102, it is detected whether the power transmission coil portion 11 is drawn or extruded up to a preset state (a state in which it is determined that the power transmission coil 12 is sufficiently or completely pulled out from the housing 13 of the electronic device (PC) 10 to the outside such that the power transmission coil 12 or the like does not greatly affect the electronic device (PC) 10) in a mechanical manner, or an electrical manner, or a combination of the mechanical manner and the electrical manner.

When it is detected that the power transmission coil portion 11 is drawn or extruded up to the preset state, the process proceeds to step S103 (Yes). When it is not detected that the power transmission coil portion 11 is drawn or extruded up to the preset state, the process proceeds to step S101 and the above processing is repeated (No).

In step S103, it is detected whether the power transmission coil portion 11 is sufficiently drawn or extruded from the housing 13 of the electronic device (PC) 10 to the outside, such that heat generation of the power transmission coil 12 is not problematic to the electronic device (PC) 10, and thus, the contactless power transmission (power feeding) to the external device (portable information terminal 20 or the like) is possible.

When it is detected that the contactless power transmission (power feeding) to the external device (portable information terminal 20 or the like) is possible, the process proceeds to step S104 (Yes). When it is detected that the contactless power transmission (power feeding) to the external device (portable information terminal 20 or the like) is impossible, the process proceeds to step S105 (No).

In step S104, the contactless power feeding (power transmission) from the electronic device (PC) 10 to the external device (portable information terminal 20 or the like) is performed. Subsequently, the process proceeds to step S106.

In step S105, the contactless power feeding (power transmission) from the electronic device (PC) 10 to the external device (portable information terminal 20 or the like) is stopped or is not performed. Subsequently, the process proceeds to step S106.

Step S106 is a termination step, and the processing is terminated.

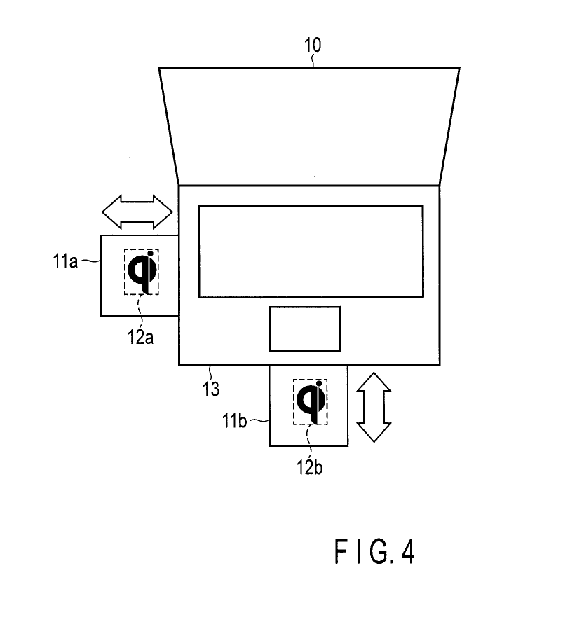

FIG. 4 is a diagram illustrating an electronic device (PC) according to another embodiment.

A power transmission coil portion (tray) is provided in the electronic device (PC) 10 at a different position compared to the electronic device (PC) 10 illustrated in FIG. 1.

That is, herein, a power transmission coil portion (tray) 11a is provided on a left side of the electronic device (PC) 10 illustrated in FIG. 4. Also, a power transmission coil portion (tray) 11b is provided in front of the electronic device (PC) 10 illustrated in FIG. 4.

Also, if necessary, a plurality of power transmission coil portions (trays) may be installed in the electronic device (PC) 10.

Also, in this embodiment, the contactless power feeding (power transmission) from the electronic device (PC) 10 to the external device (portable information terminal 20 or the like) is not limited to a case where the electronic device (PC) 10 is operating.

For example, even when the electronic device (PC) 10 is in a “sleep” state or the power of the electronic device (PC) 10 is OFF, it can be set to enable the contactless power feeding (power transmission) from the electronic device (PC) 10 to the external device (portable information terminal 20 or the like).

Therefore, without being limited to the case where the electronic device (PC) 10 is operating, for example, even when the electronic device (PC) 10 is in a “sleep” state or the power of the electronic device (PC) 10 is OFF, it is possible to perform the contactless power feeding (power transmission) from the electronic device (PC) 10 to the external device (portable information terminal 20 or the like).

Alternatively, for example, when the electronic device (PC) 10 is in a “sleep” state or the power of the electronic device (PC) 10 is OFF, it can be set to disable the contactless power feeding (power transmission) from the electronic device (PC) 10 to the external device (portable information terminal 20 or the like).

According to the embodiment, for example, it is possible to perform the contactless power feeding (power transmission) from the electronic device (PC) 10 to the external device (portable information terminal 20 or the like), without separately preparing or installing a dedicated power transmission device in the electronic device (PC) 10.

That is, the electronic device (PC) 10 according to the embodiment, for example, includes the housing 13.

Also, the power transmission coil 12 used for the contactless power feeding is embedded in the tray-shaped power transmission coil portion 11.

The power transmission coil portion 11 is configured to be held in the housing of the electronic device (PC) 10.

Also, the power transmission coil portion 11 is configured to slide with respect to the housing 13 by a mechanical control, an electrical control of a switch or the like, or a combination of the mechanical control and the electrical control.

The power transmission coil portion 11 is configured to be drawn or extruded from the housing 13 of the electronic device (PC) 10 by, for example, a manual manner, an electrically-operative manner, or a combination of the manual manner and the electrically-operative manner.

Also, detecting whether the power transmission coil portion 11 is drawn or extruded is performed mechanically or electrically.

Also, the power transmission coil portion is configured to partially or entirely overlap an optical drive (ODD) 22 in a state of being held in the housing 13.

By the above-described configuration, in this embodiment, the power transmission by the contactless power feeding can be performed even during the use of the electronic device (PC), making it possible to improve a user convenience.

Also, the procedure of the control processing of the embodiment can be all executed by software. Therefore, the same effect as in the embodiment can be easily achieved by just installing a program for executing the functions corresponding to the procedure of the control processing in a typical computer through a non-transitory computer-readable recording medium, which stores the program, and executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a power transmission coil portion comprising a power transmission coil for a contactless power feeding;
a housing configured to hold the power transmission coil portion such that the power transmission coil portion is able to be drawn or extruded from the housing;
a detector configured to detect whether the power transmission coil portion is drawn or extruded up to a preset state; and
a power transmitter configured to transmit power by the power transmission coil when the power transmission coil portion is drawn or extruded up to the preset state.

2. The electronic device of claim 1, wherein the power transmission coil portion is configured to transmit the power in the drawn or extruded state.

3. The electronic device of claim 1, wherein the housing is configured to hold the power transmission coil portion such that the power transmission coil portion is able to be slidably drawn or extruded from the housing.

4. The electronic device of claim 1, wherein the power transmission coil portion is configured to be a tray shape.

5. The electronic device of claim 1, wherein the detector is configured to mechanically or electrically detect whether the power transmission coil portion is drawn or extruded.

6. The electronic device of claim 1, wherein the power transmission coil portion is configured to partially or entirely overlap an optical drive in a state of being held in the housing.

7. A control method for controlling an electronic device, the method comprising:
detecting whether a power transmission coil portion is drawn or extruded up to a preset state, the power transmission coil portion comprising a power transmission coil for a contactless power feeding and configured such that the power transmission coil is held in a housing and is able to be drawn or extruded from the housing; and
transmitting power by the power transmission coil when the power transmission coil portion is drawn or extruded up to the preset state.

8. The electronic device control method of claim 7, wherein the transmitting comprises transmitting the power in the drawn or extruded state.

9. The electronic device control method of claim 7, wherein the detecting comprises mechanically or electrically detecting whether the power transmission coil portion is drawn or extruded.

10. A non-transitory computer-readable storage medium having stored thereon a computer program which is executable by a computer, the computer program controls the computer to execute functions of:
detecting whether a power transmission coil portion is drawn or extruded up to a preset state, the power transmission coil portion comprising a power transmission coil for a contactless power feeding and configured such that the power transmission coil is held in a housing and is able to be drawn or extruded from the housing; and
transmitting power by the power transmission coil when the power transmission coil portion is drawn or extruded up to the preset state.

11. The non-transitory computer readable storage medium of claim 10, wherein the transmitting comprises transmitting the power in the drawn or extruded state.

12. The non-transitory computer readable storage medium of claim 10, wherein the detecting comprises mechanically or electrically detecting whether the power transmission coil portion is drawn or extruded.
